(19) United States
(12) Patent Application Publication
(10) Pub. No.: US 2024/0368733 A1
(43) Pub. Date: Nov. 7, 2024

(54) METHOD FOR RECOVERING VALUABLE METALS FROM SPENT CATALYSTS

(71) Applicant: Kenit International, Inc., Fountain Valley, CA (US)

(72) Inventors: O Hak KWON, Seoul (KR); Jong Hwa CHOI, Gyeonggi-do (KR); Jong Gyu PARK, Busan (KR); Lan KWON, Jeollanam-do (KR); Hye Won JANG, Jeollanam-do (KR)

(21) Appl. No.: 18/652,140

(22) Filed: May 1, 2024

(30) Foreign Application Priority Data
May 3, 2023 (KR) 10-2023-0057818

(51) Int. Cl. C22B 34/22; C22B 3/44; C22B 7/00; C22B 34/34

(52) U.S. Cl. CPC C22B 34/225; C22B 3/44; C22B 7/008; C22B 34/345

(57) ABSTRACT

A method for recovering valuable metals is disclosed. The method includes: a spent catalyst preparation step in which a spent catalyst is prepared; and a leaching step in which a first inorganic compound containing VO₃⁻ is leached from the spent catalyst at a temperature of less than 100° C. under normal pressure.

### FIELD

The present invention relates to a method for recovering valuable metals from spent catalysts.

### BACKGROUND

A catalyst is a substance that increases the rate of a chemical reaction without undergoing any change and is indispensable to oil refining and petrochemical processes. Although the amount of catalyst used in oil refining and petrochemical processes is small compared to a raw material fed into the processes, consumption of catalysts is growing with increase in number of oil refineries and petrochemical plants.

In particular, in oil refineries and petrochemical plants, various catalysts containing valuable metals, such as molybdenum, vanadium, nickel, and aluminum, are used. However, such catalysts containing valuable metals gradually degrade over time, reach the end of their service life, and are eventually replaced. Typically, such end-of-life catalysts have been buried without any special treatment, soil contamination has occurred due to heavy metals leaching therefrom and contaminating groundwater and high-value added metals that can be utilized as materials for high-tech industries have been discarded without being recycled.

In response to the above problems, various methods have been proposed to recover valuable metals, including precious metals such as molybdenum and vanadium, from end-of-life catalysts generated from oil refining and petrochemical processes in order to minimize soil pollution and to recycle high-value added metals that depend on imports.

However, especially in the case of recovering valuable metals from spent desulfurization catalysts, conventional methods require roasting at high temperatures and/or high pressures, resulting in environmental pollution and excessive energy costs due to generation of harmful gases, such as sulfur dioxide, and economic losses due to complex processes and the need for separate facilities.

Moreover, since the use of such a high temperature and high pressure process makes it impossible to recover and recycle aluminum, nickel, and aluminum, such metals are discarded as industrial waste, causing environmental pollution and significant economic losses.

### SUMMARY

It is one aspect of the present invention to provide a method for recovering valuable metals from spent catalysts that does not produce harmful gases, such as SOₓ, and liquid waste.

It is another aspect of the present invention to provide a method for recovering valuable metals from spent catalysts that does not require high temperature and/or high pressure processes to remove sulfur and the like from spent catalysts or to leach out metal compounds.

It is a further aspect of the present invention to provide a method for recovering valuable metals from spent catalysts that can recover not only vanadium but also molybdenum, aluminum, and nickel with high recovery rates.

In accordance with one aspect of the present invention, a method for recovering valuable metals includes: a spent catalyst preparation step in which a spent catalyst is prepared; and a leaching step in which a first inorganic compound containing VO₃⁻ is leached from the spent catalyst at a temperature of less than 100° C. under normal pressure.

In one embodiment, the leaching step may include: stirring the prepared spent catalyst in a leaching solution containing sodium hydroxide at a temperature of less than 100° C. under normal pressure.

In one embodiment, the leaching solution may be an aqueous solution containing sodium hydroxide at a concentration of 3% to 20%.

In one embodiment, the leaching step may include: adding oxygen or air.

In one embodiment, the method may be free from heat treatment of the spent catalyst at a temperature of 100° C. or greater after the spent catalyst preparation step and before the leaching step.

In one embodiment, the method may further include: after the leaching step, a precipitation step in which a second inorganic compound containing VO₃⁻ is precipitated by addition of a salt to the first inorganic compound leached out in the leaching step.

In one embodiment, the salt added in the precipitation step may be ammonium chloride.

In one embodiment, the method may further include: producing ammonium chloride by addition of hydrochloric acid to ammonia produced after oxidation of the second inorganic compound precipitated in the precipitation step and reusing the produced ammonium chloride.

In one embodiment, the method may further include: after the precipitation step, obtaining vanadium oxide by oxidation of the second inorganic compound precipitated in the precipitation step.

In one embodiment, the method may further include: after the precipitation step, obtaining at least one selected from among nickel, a nickel compound, aluminum, an aluminum compound, molybdenum, and a molybdenum compound.

The method for recovering valuable metals according to the present invention does not produce harmful gases, such as SOₓ, and liquid waste, such as a waste leaching solution, thereby significantly reducing environmental pollution and economic costs associated therewith.

In addition, the method for recovering valuable metals according to the present invention does not require high temperature and/or high pressure processes to remove sulfur and the like from spent catalysts or to leach out metal compounds, thereby significantly reducing energy costs associated therewith.

In addition, the method for recovering valuable metals according to the present invention can recover not only vanadium, but also molybdenum, aluminum and nickel with high recovery rates.

### DRAWINGS

FIG. 1 is a diagram illustrating a process according to one embodiment of the present invention.

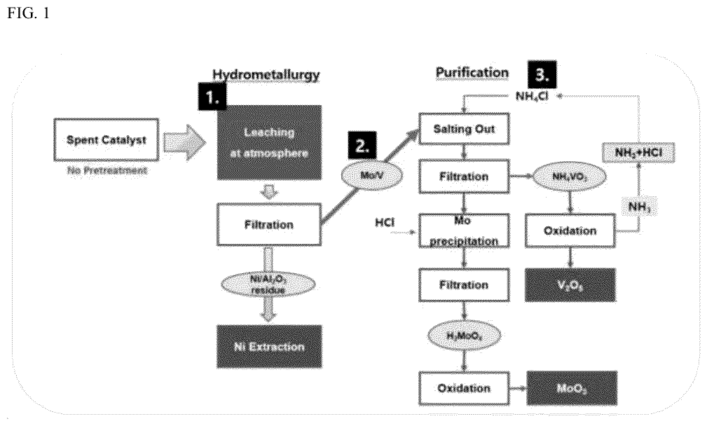

### DETAILED DESCRIPTION

As used herein, the terms “comprising”, “including”, etc. should be understood as open-ended terms that do not exclude the presence of other configurations.

As used herein, the terms “preferred” and “preferably” refer to embodiments of the present invention that can provide predetermined benefits under predetermined circumstances. However, these terms are not intended to exclude other embodiments from the scope of the present invention.

As used herein, the singular forms, “a”, “an,” and “the” are intended to include the plural forms as well, unless the context clearly indicates otherwise.

As used herein, the terms “first”, “second”, and the like are not intended to be limiting, but rather are used to distinguish one element from another.

As used herein, numerical ranges are meant to be inclusive of their upper and lower limits, all values within their upper and lower limits, increments logically derived from their form and width, all values defined by increments, and all possible combinations of upper and lower limits defined in different forms.

Unless otherwise defined herein, values outside a defined numerical range that may occur due to experimental errors or rounding operations are also included in the numerical range.

The technical features described below relate to embodiments of the present invention that can achieve the intended benefits of the present invention. That is, a method for recovering valuable metals according to the present invention can provide the aforementioned benefits by including the technical features according to embodiments described below.

The present invention relates to a method for recovering valuable metals from spent catalysts.

In the field of oil refining and petrochemicals, catalysts are used to smoothly remove sulfur and the like from crude oil. Such catalysts have a lifespan of about 3 to 5 months and are replaced periodically. End-of-life catalysts are referred to as spent catalysts.

A spent catalyst may contain one or more valuable metals selected from among vanadium, molybdenum, cobalt, aluminum, and nickel.

As used herein, “recovering a valuable metal” means not only recovering a valuable metal itself, but also recovering a compound containing a valuable metal in marketable form.

The present invention provides a simple, economical and environmentally friendly method for extracting and recovering valuable metals and/or a compound containing valuable metals from spent catalysts.

By way of example, the compound containing valuable metals may be (NH₄)VO₃ or vanadium(V) oxide (V₂O₅). The compound or vanadium contained therein may be used as a raw material for alloy steel, a material for aviation, automobile, and electronics applications, a raw material for next-generation redox batteries, etc.

By way of example, the compound containing valuable metals may be molybdenum trioxide (MoO₃). The compound or molybdenum contained therein may be used as a raw material for special alloy steel, a raw material for military and industrial machinery applications, etc.

By way of example, the compound containing valuable metals may be nickel oxide (NiO). The compound or nickel contained therein may be used as a raw material for battery anode materials, a raw material for heat-resistant stainless steel, etc.

By way of example, the compound containing valuable metals may be aluminum oxide (Al₂O₃) or aluminum hydroxide (Al(OH)₃). The compound or aluminum contained therein may be used as a raw material for packaging materials (for example, cans, foils, etc.), building materials, etc.

By way of example, the compound containing valuable metals may be an oxide containing cobalt. The compound or cobalt contained therein may be used as a raw material for secondary battery anode materials, etc.

First, the method includes a spent catalyst preparation step in which a spent catalyst as described above is prepared.

Here, the prepared spent catalyst may be a spent desulfurization catalyst.

In one embodiment, in the spent catalyst preparation step, the spent catalyst may be pulverized alone, or may be pulverized in an aqueous solution of sodium hydroxide. The pulverized spent catalyst may have a size of 100 μm or less. Here, the spent catalyst may be pulverized using any typical pulverizer, such as a ball mill.

Next, the method includes a leaching step in which a first VO₃⁻-containing inorganic compound is leached from the prepared spent catalyst at a temperature of less than 100° C., 98° C. or less (or less than 98° C.), or 95° C. or less (or less than 95° C.), preferably at a temperature of 50° C. or more (or higher than 50° C.), 60° C. or more (or higher than 60° C.), 70° C. or more (or higher than 70° C.), or 80° C. or more (or higher than 80° C.), more preferably at a temperature of 85° C. or more (or higher than 85° C.).

The leaching step is carried out at normal pressure.

Here, “normal pressure” refers to a pressure under normal conditions without using a separate pressure-reducing device or pressurizing device, such as a vacuum pump. For example, normal pressure may be a pressure of about 760 mmHg, which is standard atmospheric pressure.

Advantageously, the method according to the present invention allows use of inexpensive plastic reactors, instead of pressure-resistant reactors, since the reaction temperature is below the boiling point of water and thus the pressure in a reactor is automatically maintained at 1 atmosphere or less.

In one embodiment, the leaching step may include stirring the prepared spent catalyst in a sodium hydroxide-containing leaching solution at a temperature of less than 100° C. under normal pressure.

Specifically, the spent catalyst may be subjected to hydrometallurgy through stirring in the sodium hydroxide-containing leaching solution, for example, an aqueous solution of sodium hydroxide.

Preferably, a mass ratio of the sodium hydroxide-containing leaching solution to the spent catalyst ranges from 1 to 40, 5 to 30, or 10 to 20.

Advantageously, the method according to the present invention prevents emission of sulfuric acid gas by leaching the spent catalyst with the aqueous solution of sodium hydroxide under the above temperature and pressure conditions and prevents generation of liquid waste by recovering and reusing the aqueous solution of sodium hydroxide.

Preferably, the sodium hydroxide-containing leaching solution is an aqueous solution containing sodium hydroxide at a concentration of 3% or more, 4% or more, 5% or more, 20% or less, 15% or less, 10% or less, or 7% or less. Within this range of sodium hydroxide concentration in the aqueous solution used as the leaching solution, valuable metals can be recovered with high yields under low temperature and normal pressure conditions.

In one embodiment, the leaching step may further include adding oxygen or air during leaching with the hydroxide-containing leaching solution at a temperature of less than 100° C. under normal pressure.

The leaching step may produce vanadium in a trivalent oxidation state as an intermediate product. For example, the intermediate product produced in the leaching step may be NaVO₂.

In one embodiment, the first VO₃⁻-containing inorganic compound leached out in the leaching step may be sodium metavanadate (NaVO₃).

Next, the leaching step may further include a filtration step in which the first VO₃⁻-containing inorganic compound is filtered. The filtration step may be carried out by any typical method known in the art.

In one embodiment, in the filtration step, the first VO₃⁻-containing inorganic compound may be separated into a solid phase containing nickel, aluminum, cobalt, etc. and a liquid phase containing vanadium, molybdenum, etc.

In one embodiment, in the filtration step, nickel, aluminum, cobalt, etc. contained in the solid phase may be extracted separately from each other.

Next, the method may further include a precipitation step in which a second VO₃⁻-containing inorganic compound is precipitated by addition of a salt to the first VO₃^{'1}-containing inorganic compound leached out in the leaching step. Here, prior to addition of the salt, the solution containing the first VO₃⁻-containing inorganic compound may be adjusted to a pH of 7 by addition of an acid, such as hydrochloric acid.

By way of example, the salt added in the precipitation step may be ammonium chloride.

Preferably, ammonium chloride is added in a molar ratio of 2 to 4 or 2.5 to 3.5 relative to vanadium leached in the leaching step.

By way of example, the second VO₃⁻-containing inorganic compound precipitated in the precipitation step may be ammonium metavanadate ((NH₄)VO₃).

By way of example, the precipitation step may be represented by Reaction Formula 1.

NaVO₃+NH₄Cl→(NH₄)VO₃↓+NaCl <Reaction Formula 1>

In one embodiment, the precipitation step may further include a filtration step in which the precipitated second inorganic compound is filtered. The filtration step may be carried out by any typical method known in the art.

Next, the method may further include a vanadium oxide obtainment step in which vanadium oxide is obtained by oxidation of the precipitated second VO₃⁻-containing inorganic compound.

By way of example, the vanadium oxide may be vanadium (V) oxide (V₂O₅). The vanadium oxide obtainment step may be carried out by any suitable method that can obtain the vanadium oxide from the precipitated second VO₃⁻-containing inorganic compound.

Advantageously, the method does not require heat treatment of the spent catalyst at a temperature of 100° C. or greater after the waste catalyst preparation step and before the leaching step.

Advantageously, the method does not require a separate pretreatment step, such as removal of oil or sulfur from the spent catalyst, oxidation of the spent catalyst, and the like.

In conventional methods, a spent catalyst is roasted to remove oil or sulfur therefrom. This process requires separate facilities. In contrast, the method does not require roasting the spent catalyst at a temperature of 100° C. or greater to remove sulfur and the like after the waste catalyst preparation step and before the leaching step, thereby eliminating the need for separate facilities associated therewith and ensuring little or no emissions of harmful gases such as SOₓ and thus enhanced environmental friendliness.

Furthermore, the method according to the present invention does not require heat treatment of the spent catalyst at a temperature of 100° C. or more during the leaching step since the first VO₃⁻-containing inorganic compound is leached out at a temperature of less than 100° C. and normal pressure, as described above.

Specifically, after the waste catalyst preparation step and before the leaching step or during the leaching step, the method does not require heat treatment of the spent catalyst at a temperature of 100° C. or more, 200° C. or more, 300° C. or more, 400° C. or more, 500° C. or more, 600° C. or more, 700° C. or more, or 800° C. or more.

Preferably, the method further includes producing ammonium chloride by addition of hydrochloric acid to ammonia produced ar oxidation of the second inorganic compound precipitated in the precipitation step and reusing the produced ammonium chloride.

In one embodiment, the method may further include obtaining at least one selected from among nickel, a nickel compound, aluminum, an aluminum compound, molybdenum, and a molybdenum compound.

The step of obtaining the nickel compound and/or nickel may be carried out through a separate separation process after the leaching step in which the first VO₃⁻-containing inorganic compound is leached out. Here, the separation process may be carried out by any typical method known in the art. By way of example, nickel or the nickel compound may be extracted from a Ni/Al₂O₃ residue formed in the leaching step.

The step of obtaining the molybdenum compound and/or molybdenum may be carried out through a separate separation process after the leaching step in which the first VO₃⁻-containing inorganic compound is leached out. Here, the separation process may be carried out by any typical method known in the art.

Preferably, the method further includes a molybdic acid reagent addition step in which a molybdic acid (H₂MoO₄) reagent is added in a molar ratio of 3 to 7 or 4 to 6 relative to molybdenum to an extracted solution with vanadium recovered therefrom after the precipitation step in which the second VO₃⁻-containing inorganic compound is precipitated.

After addition of the molybdic acid (H₂MoO₄) reagent, molybdenum may be obtained by heating the extracted solution to a temperature of 70° C. to 90° C., followed by adjusting the extracted solution to a pH of 2.5 to 3.5 through addition of an acid.

The step of obtaining the aluminum compound and/or aluminum may be carried out through a separate separation process after the leaching step in which the first VO₃⁻-containing inorganic compound is leached out. Here, the separation process may be carried out by any typical method known in the art.

The method according to the present invention ensures recovery of nickel and/or aluminum by performing the leaching process at a temperature of less than 100° C. and normal pressure while omitting the process of roasting the spent catalyst.

Next, the present invention will be described in more detail with reference to some examples.

### EXAMPLE

### Leaching of Vanadium/Molybdenum

First, 30 g of spent desulfurization catalyst pellets from an oil refinery company in Korea was pulverized using a ball mill. Here, the spent desulfurization catalyst contained substances listed in Table 1.

TABLE 1
Spent desulfurization catalyst from oil refinery company in Korea

| | Vanadium | Molybdenum | Nickel | Aluminum | |
|---|---|---|---|---|---|
| Substance | (V) | (Mo) | (Ni) | (Al) | Oil |
| Content (%) | 15.8 | 2.5 | 3.8 | 16.0 | 19.0 |

The pulverized raw material was placed in a 1 L glass reactor, followed by addition of 360 g of a leaching solution containing sodium hydroxide (NaOH) at a concentration of 10% to the reactor, and then the reactor was heated to 90° C. while stirring at a rate of 250 rpm, followed by supplying air to the leaching solution at a rate of 300 cc/min using a gas bubbler, thereby extracting a solution containing metals.

The content of metals in the extracted solution was analyzed by inductively coupled plasma mass spectrometry (ICP-MS), and the extraction rate of vanadium and molybdenum was calculated using Equation 1.

$$Extraction rate of each metal ( \% ) = \frac{Weight of metal ( Mo , V ) in extracted solution}{\begin{matrix}Weight of metal ( Mo , V ) in \\ spent catalyst as raw material\end{matrix}} \times 100 \qquad < Equation 1 >$$

Table 2 shows results of analyzing the extraction rate of each metal as a function of reaction time.

TABLE 2
Extraction rate of vanadium and molybdenum as function of
reaction time:

| Reaction | Extraction rate (%) of vanadium | Extraction rate (%) of |
|---|---|---|
| time (hr) | (V) | molybdenum (Mo) |
| 1 hr | 85.2 | 45.4 |
| 3 hr | 91.2 | 95.1 |
| 5 hr | 93.5 | 96.9 |
| 7 hr | 95.0 | 99.9 |

### Precipitation and Recovery of Vanadium

200 g of the extracted solution containing vanadium and molybdenum was placed in a 500 ml reactor, followed by stirring at 200 rpm at room temperature, and then the resulting solution was adjusted to a pH of 7 through addition of hydrochloric acid (5%).

Thereafter, ammonium chloride (NH₄Cl) powder was added to the resulting solution, thereby precipitating vanadium in the form of ammonium vanadate (NH₄VO₃). Here, the ammonium chloride powder was added in a molar ratio of 3 relative to vanadium contained in the solution.

The recovery rate of vanadium in the form of ammonium vanadate (NH₄VO₃) was calculated using Equation 2.

$$Recovery rate of vanadium ( \% ) = \frac{Weight of recovered metal ( Mo , V )}{Weight of metal ( Mo , V ) in extracted solution} \times 100 \qquad < Equation 2 >$$

Table 3 shows results of analyzing the recovery rate of vanadium as a function of reaction time after addition of ammonium chloride.

TABLE 3
Recovery rate of vanadium

| | | Reaction | Recovery rate (%) of |
|---|---|---|---|
| pH | Temperature | time (hr) | vanadium (V) |
| 7 | Room temperature | 1 hr | 94.8% |
| 7 | Room temperature | 3 hr | 99.2% |
| 7 | Room temperature | 5 hr | 99.4% |

### Precipitation and Recovery of Molybdenum

200 g of the extracted solution remaining after recovery of vanadium in the vanadium precipitation step was placed in a 500 ml glass reactor, followed by adding a molybdic acid (H₂MoO₄) reagent in a molar ratio of 5 (5 equivalents) relative to molybdenum in the extracted solution while stirring at 200 rpm.

Thereafter, the extracted solution was heated to 80° C., followed by adding hydrochloric acid (5%) until the solution reached a pH of 3. Thereafter, the extracted solution was analyzed as a function of time, thereby calculating the recovery rate of molybdenum in the same manner as in calculation of the recovery rate of vanadium.

Table 4 shows results of analyzing the recovery rate of molybdenum as a function of reaction time.

TABLE 4
Recovery rate of molybdenum

| | | | Recovery rate (%) of |
|---|---|---|---|
| pH | Temperature | Reaction time (hr) | molybdenum (Mo) |
| 3 | 80° C. | 1 hr | 93.5% |
| 3 | 80° C. | 3 hr | 99.2% |
| 3 | 80° C. | 5 hr | 99.3% |

1. A method for recovering valuable metals, comprising:
a spent catalyst preparation step in which a spent catalyst is prepared; and
a leaching step in which a first inorganic compound containing VO₃⁻ is leached from the spent catalyst at a temperature of less than 100° C. under normal pressure.

2. The method according to claim 1, wherein the leaching step comprises: stirring the prepared spent catalyst in a leaching solution containing sodium hydroxide at a temperature of less than 100° C. under normal pressure.

3. The method according to claim 2, wherein the leaching solution is an aqueous solution containing sodium hydroxide at a concentration of 3% to 20%.

4. The method according to claim 1, wherein the leaching step comprises: adding oxygen or air.

5. The method according to claim 1, wherein the method is free from heat treatment of the spent catalyst at a temperature of 100° C. or greater after the spent catalyst preparation step and before the leaching step.

6. The method according to claim 1, further comprising: after the leaching step,
a precipitation step in which a second inorganic compound containing VO₃⁻; is precipitated by addition of a salt to the first inorganic compound leached out in the leaching step.

7. The method according to claim 6, wherein the salt added in the precipitation step is ammonium chloride.

8. The method according to claim 6, further comprising:
producing ammonium chloride by addition of hydrochloric acid to ammonia produced after oxidation of the second inorganic compound precipitated in the precipitation step and reusing the produced ammonium chloride.

9. The method according to claim 6, further comprising: after the precipitation step,
obtaining vanadium oxide by oxidation of the second inorganic compound precipitated in the precipitation step.

10. The method according to claim 6, further comprising: after the precipitation step,
obtaining at least one selected from among nickel, a nickel compound, aluminum, an aluminum compound, molybdenum, and a molybdenum compound.
